(19) United States
(12) Patent Application Publication
(10) Pub. No.: US 2002/0151406 A1
(43) Pub. Date: Oct. 17, 2002

(54) Clutch packs, steel, vehicles and methods of operating a transmission

(76) Inventor: Brian Williams, Mullan, ID (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/172,596

(22) Filed: Jun. 12, 2002

Related U.S. Application Data
(62) Division of application No. 09/805,695, filed on Mar. 13, 2001.

(51) Int. Cl. F16H 57/08

(52) U.S. Cl. 475/331

(57) ABSTRACT

A transmission, a vehicle, a method of forming a transmission, a clutch pack, and a method of operating a transmission are provided. According to one aspect, a transmission includes a first shaft configured to rotate about an axis; a second shaft configured to rotate about an axis; and a coupling device coupled with the first shaft and the second shaft, the coupling device comprising a plurality of components configured to impart rotational forces received by one of the first and second shafts to the other of the first and second shafts and to provide a plurality of transmission ratios intermediate the first and second shafts, and wherein at least a portion of at least one of the components is coated with a first material different than a second material comprising the at least one coated component.

### TECHNICAL FIELD

This invention relates to a transmission, a vehicle, a method of forming a transmission, a clutch pack, and a method of operating a transmission.

### BACKGROUND OF THE INVENTION

Automatic transmissions have gained wide acceptance in many automotive and truck applications. Automatic transmissions offer ease of use without burdening the driver with issues of frequently choosing appropriate gearing and physically implementing changes of transmission ratios.

During operation, automatic transmissions generate internal heat. For example, slippage of fiber discs and steels of clutch packs generates heat. Excessive heat can lead to premature failure of a given transmission.

One function of lubricating fluid within automatic transmissions is to implement cooling of internal components. Often, an external transmission cooler may be provided to increase the heat dissipation and rejection capacities of the vehicle with respect to the transmission. Increased fluid movement provides improved cooling and rejection of heat generated during operation of the transmission.

Vehicles implementing automatic transmissions are frequently utilized in applications for pulling or towing considerable weight. Engine power of many vehicles has increased, thereby enhancing the towing capabilities of the vehicles. However, increased loads are placed upon the drive train and transmission. Such results in the increased generation of heat. Transmission failures are not uncommon in applications where engine output power has been increased and/or the vehicle has been used to frequently tow loads of considerable weight.

There exists a need to provide improved transmission configurations and methodologies for effecting changes in transmission ratios.

### BRIEF DESCRIPTION OF THE DRAWINGS

Preferred embodiments of the invention are described below with reference to the following accompanying drawings.

FIG. 1 is a graphical representation of a vehicle embodying an exemplary transmission according to aspects of the present invention.

FIG. 2 is a graphical representation of an exemplary automatic transmission embodying aspects of the present invention.

FIG. 3 is an exploded view of an exemplary front clutch configuration of the automatic transmission shown in FIG. 2.

FIG. 4 is an exploded view of an exemplary rear clutch configuration of the automatic transmission of FIG. 2.

FIG. 5 is an exploded view of an exemplary overdrive clutch configuration of the automatic transmission of FIG. 2.

FIG. 6 is an exploded view of an exemplary direct clutch configuration of the automatic transmission of FIG. 2.

FIG. 7 is an exploded view of an exemplary planetary gear assembly of the automatic transmission shown in FIG. 2.

FIG. 8 is an elevation view of an exemplary steel utilized in clutch packs of the automatic transmission in FIG. 2.

FIG. 9 is a cross-sectional view depicting exemplary coatings over a base material of components of the automatic transmission according to aspects of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

According to one aspect of the present invention, a transmission comprises: a first shaft configured to rotate about an axis; a second shaft configured to rotate about an axis; and a coupling device coupled with the first shaft and the second shaft, the coupling device comprising a plurality of components configured to impart rotational forces received by one of the first and second shafts to the other of the first and second shafts and to provide a plurality of transmission ratios intermediate the first and second shafts, and wherein at least a portion of at least one of the components is coated with a first material different than a second material comprising the at least one coated component.

A second aspect of the invention provides a vehicle comprising: a support member; an engine coupled with the support member and configured to provide a rotational force; a transmission coupled with the engine, and comprising: a first shaft configured to rotate about an axis; a second shaft configured to rotate about an axis, wherein one of the first and second shafts is configured to receive the rotational force from the engine; and a coupling device coupled with the first shaft and the second shaft, the coupling device comprising a plurality of components configured to impart the rotational force received by one of the first and second shafts to the other of the first and second shafts and to provide a plurality of transmission ratios intermediate the first and second shafts, and wherein at least a portion of at least one of the components is coated with a first material different than a second material comprising the at least one coated component.

Another aspect of the present invention provides a method of forming a transmission comprising: providing a first shaft configured to rotate about an axis; providing a second shaft configured to rotate about an axis; coupling a coupling device with the first shaft and the second shaft, the coupling device comprising a plurality of components configured to impart rotational forces received by one of the first and second shafts to the other of the first and second shafts and to provide a plurality of transmission ratios intermediate the first and second shafts; and coating at least a portion of at least one of the components of the coupling device with a first material different than a second material comprising the at least one coated component.

The invention provides in another aspect a clutch pack comprising: a plurality of steels configured to rotate about an axis; and a friction member positioned intermediate the steels and configured to selectively rotate with the steels and to selectively rotate independent of the steels, wherein the steels individually comprise an annular member having an inner radius and an outer radius, and at least one of the steels includes an aperture within the annular member intermediate the inner radius and outer radius.

An additional aspect of the invention provides a transmission clutch pack steel, the steel comprising an annular member having an inner radius and an outer radius, and at least one of the steels includes at least one aperture within the annular member intermediate the inner radius and outer radius.

Another aspect of the invention provides a vehicle comprising: a support member; an engine coupled with the support member and configured to provide a rotational force; a transmission coupled with the engine, and comprising: a first shaft configured to rotate about an axis; a second shaft configured to rotate about an axis, wherein one of the first and second shafts is configured to receive the rotational force from the engine; and a coupling device coupled with the first shaft and the second shaft, the coupling device comprising a plurality of components configured to impart the rotational force received by one of the first and second shafts to the other of the first and second shafts and to provide a plurality of transmission ratios intermediate the first and second shafts, and wherein the components of the coupling device include a clutch pack comprising: a plurality of steels configured to rotate about an axis; and a friction member positioned intermediate the steels and configured to selectively rotate with the steels and to selectively rotate independent of the steels, wherein the steels individually comprise an annular member having an inner radius and an outer radius, and at least one of the steels includes an aperture within the annular member intermediate the inner radius and outer radius.

Yet another aspect of the invention provides a method of operating a transmission comprising: providing a friction member; providing a steel; rotating the steel about an axis; rotating the friction member about an axis; selectively engaging the friction member with the steel; and passing a fluid through the annular member at a location intermediate the inner radius and the outer radius during the rotating of the steel.

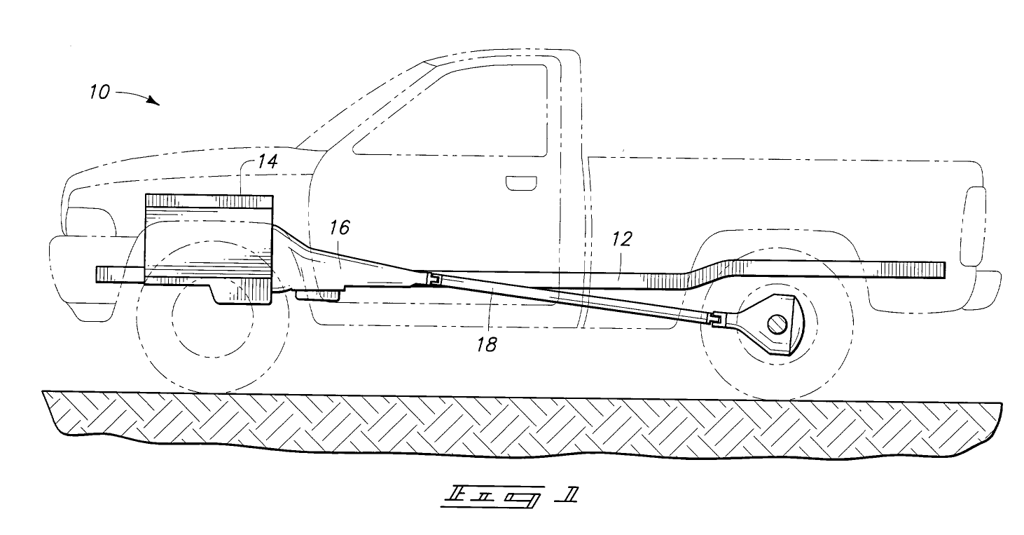

FIG. 1 depicts an exemplary automotive vehicle 10 embodying aspects of the present invention. Vehicle 10 includes a support member 12, an engine 14, a transmission 16, and a drive shaft 18.

Support member 12 comprises a frame in the depicted arrangement of vehicle 10. Other configurations of support member 12 are possible. Engine 14 is coupled with support member 12 and comprises a gasoline or diesel engine configured to provide a rotational force in the exemplary described embodiment. Transmission 16 is coupled in any suitable manner intermediate engine 14 and drive shaft 18. Transmission 16 is operable to receive rotational forces generated within engine 14 and to impart such received rotational force to drive shaft 18. In addition, transmission 16 is configured to provide a plurality of transmission ratios intermediate engine 14 and drive shaft 18.

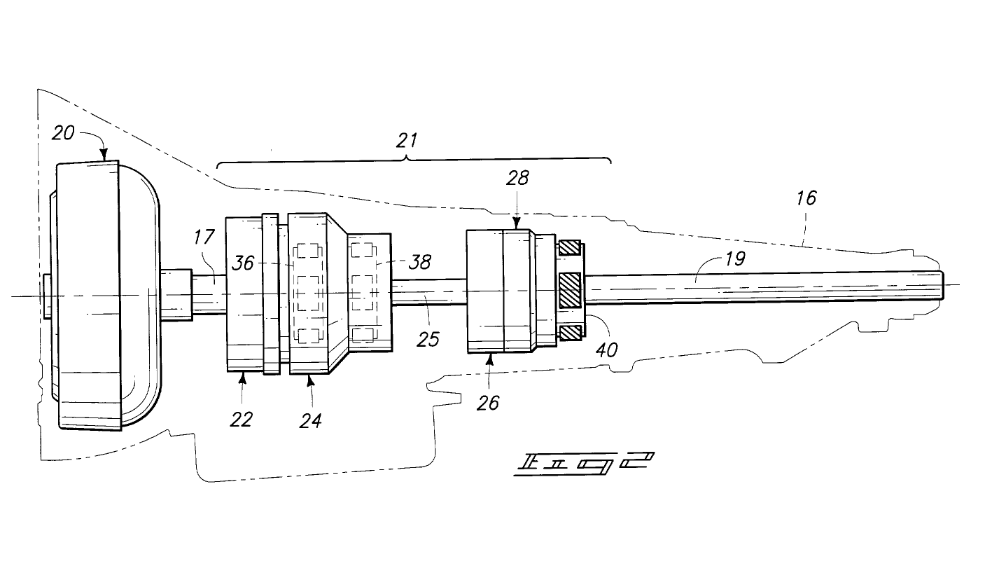

Referring to FIG. 2, further details of exemplary transmission 16 are shown. The depicted transmission is a model 46/47 RH or RE which may be secured from Chrysler Corporation of Auburn Hills, Mich. Aspects of the present invention may be utilized in other transmission configurations.

The depicted exemplary transmission 16 comprises a torque converter 20 and a coupling device 21. Torque converter 20 is configured to couple with a fly wheel (not shown) of engine 14. Transmission 16 also includes a shaft 17 coupled in any suitable manner intermediate torque converter 20 and coupling device 21. Another shaft 19 couples coupling device 21 to components externally of transmission 16. For example, shaft 19 is coupled with drive shaft 18.

The illustrated exemplary configuration of coupling device 21 comprises a plurality of components, some of which are depicted in FIG. 2. Coupling device 21 is coupled in any suitable configuration with shafts 17, 19. Shafts 17, 19 are arranged to rotate about respective axes responsive to a force. One of shafts 17, 19 is configured to receive a rotational force. Coupling device 21 is configured to impart rotational forces received by one of shafts 17, 19 to the other of shafts 17, 19.

For example, in the depicted embodiment, shaft 17 may be referred to as an input shaft configured to receive rotational forces from engine 14. In such an embodiment, shaft 19 is referred to as an output shaft configured to impart the rotational forces to external components, such as drive shaft 18.

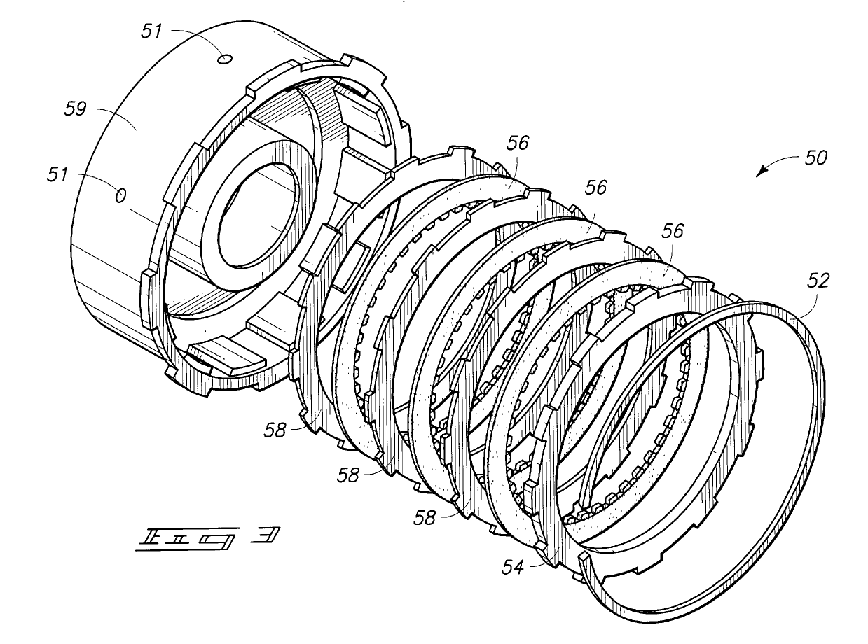

Coupling device 21 comprises a plurality of components configured to provide a plurality of transmission ratios intermediate shafts 17, 19. In the described exemplary transmission configuration disclosed herein, coupling device 21 includes a front clutch 22, a rear clutch 24, an intermediate shaft 25, an overdrive clutch 26 and a direct clutch 28 as shown. Coupling device 21 further includes a plurality of planetary gear assemblies 36, 38, 40 arranged to provide a plurality of transmission or gear ratios intermediate shafts 17, 19 as selected by a user of vehicle 10 via an appropriate gearing selection device (not shown). Referring to FIG. 3, components of an exemplary clutch pack, configuration 50 of front clutch 22 are shown. Front clutch configuration 50 includes a snap ring 52, a reaction plate 54, a plurality of friction members 56, and a plurality of steels 58.

Friction member 56 and steels 58 may be referred to as clutch or fiber discs and clutch plates, respectively. Friction members 56 are configured to spline to an internal hub (not shown) of front clutch 22. Steels 58 are configured for mating reception within a front clutch drum or retainer 59.

Friction members 56 and steels 58 are configured to rotate about an axis. Friction members 56 are positioned intermediate adjacent steels 58 as shown and are configured to selectively rotate with the steels 58 and to selectively rotate independent of the steels 58 depending upon the selection of a desired transmission ratio by the user.

More specifically, in the disclosed exemplary configuration, a clutch piston (not shown) is utilized to selectively exert an axial compression force upon clutch pack configuration 50. Upon assertion of the axial compression force, friction members 56 and steels 58 are engaged and rotate with one another. Upon removal of the compression force, friction members 56 and steels 58 rotate independently of one another. In combination with planetary gear assemblies 36, 38, 40 of coupling device 21, selective application of compression forces upon clutch pack configuration 50 and other clutch packs described herein effects a plurality of desired transmission ratios of transmission 16.

In the depicted arrangement of front clutch drum 59, a plurality of apertures 51 are provided within the annular portion thereof. Five apertures 51 individually having a diameter of 3/16″ are spaced evenly about a circumference of the annular portion of drum 59 at locations corresponding to recessed splines within the interior portion of drum 59. Apertures 51 within drum 59 pass exiting transmission fluid from drum 59. Such apertures 51 also permit cooling of a front band assembly (not shown). Apertures 51 further provide increased flow of transmission fluid exiting drum 59, and a vortex effect of such transmission fluid exiting drum 59. The depicted arrangement facilitates increased flow of transmission fluid to increase heat rejection capacities of transmission 16.

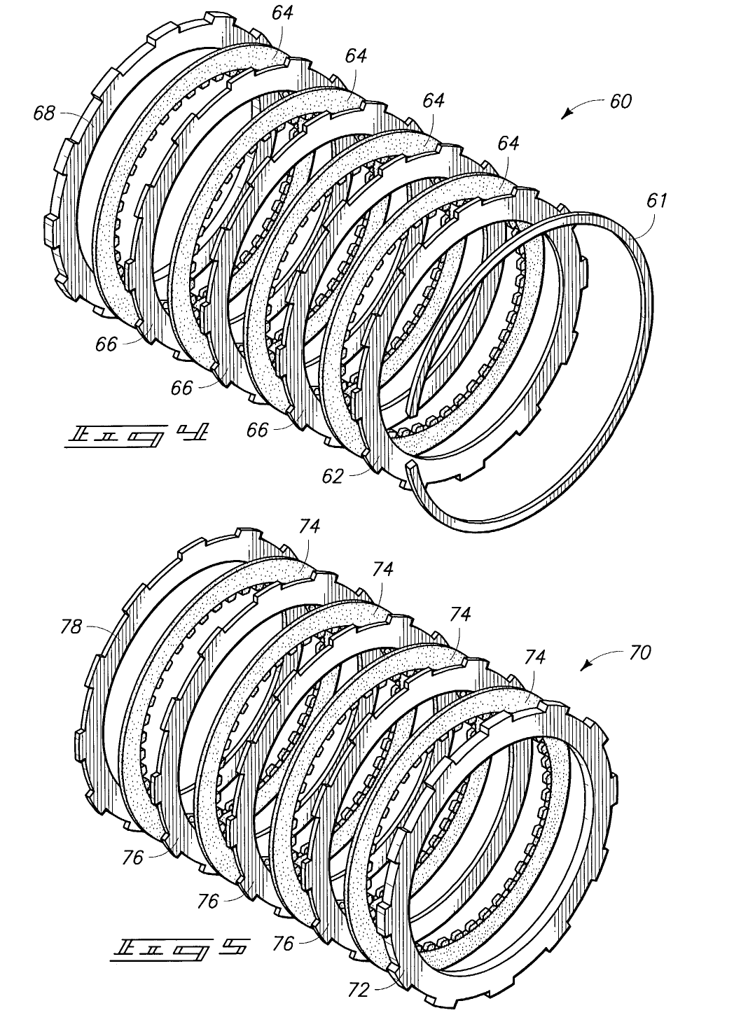

Referring to FIG. 4, components of an exemplary clutch pack configuration 60 of rear clutch 24 within transmission 16 are depicted. Clutch pack configuration 60 comprises a snap ring 61, a pressure plate 62, a plurality of friction members 64, a plurality of steels 66 and a reaction plate 68. Friction members 64 are splined with an internal hub (not shown) and steels 66 are configured to rotate with a drum or retainer (not shown). An axial compression force is selectively utilized to effect desired transmission ratios by application thereof to pressure plate 62 similar to described operation of clutch pack configuration 50.

Referring to FIG. 5, components of an exemplary clutch pack configuration 70 of overdrive clutch 26 within transmission 16 are depicted. Clutch pack configuration 70 comprises a pressure plate 72, a plurality of friction members 74, a plurality of steels 76 and a reaction plate 78. Friction members 74 are splined with an internal hub (not shown) and steels 76 are configured to rotate with a drum or retainer (not shown). An axial compression force is selectively utilized to effect desired transmission ratios by application thereof to pressure plate 72 similar to described operation of clutch pack configurations 50, 60.

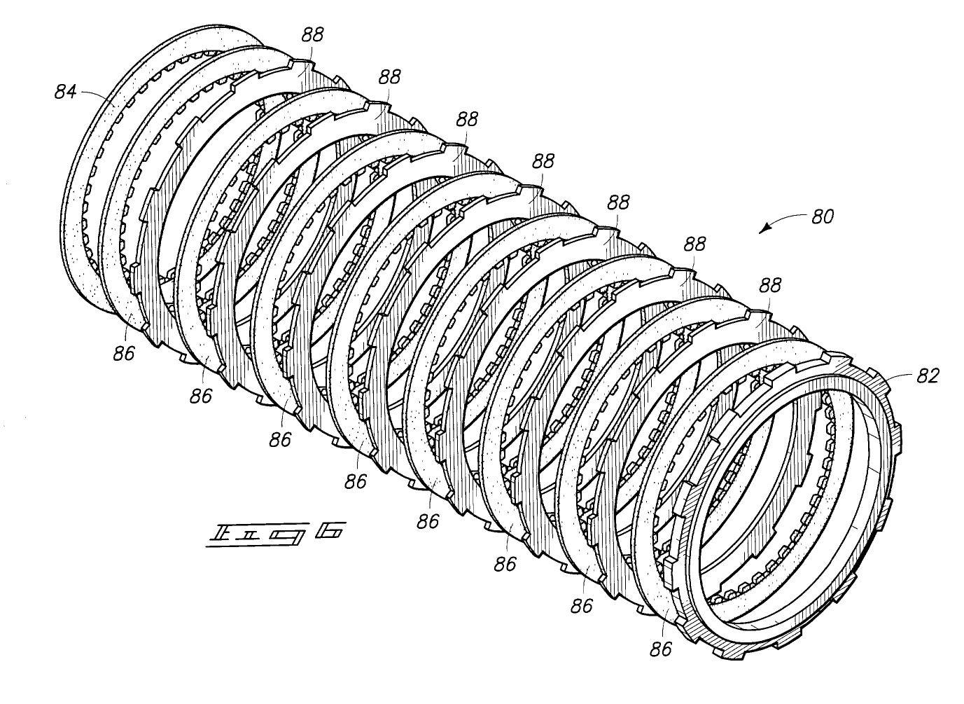

Referring to FIG. 6, components of an exemplary clutch pack configuration 80 of direct clutch 28 within transmission 16 are depicted. Clutch pack configuration 80 comprises a pressure plate 82, a reaction plate 84, a plurality of friction members 86, and a plurality of steels 88. Friction members 86 are splined with an internal hub (not shown) and steels 88 are configured to rotate with a drum or retainer (not shown). An axial compression force is selectively utilized to effect desired transmission ratios by application thereof to pressure plate 82 similar to described operation of clutch pack configurations 50, 60, 70.

Although not shown in FIG. 6, a direct clutch drum also includes a plurality of apertures within an annular portion thereof (similar to apertures 51 of drum 59 shown in FIG. 3) to provide exiting of transmission fluid from the direct clutch drum as well as a vortex effect of such exiting transmission fluid.

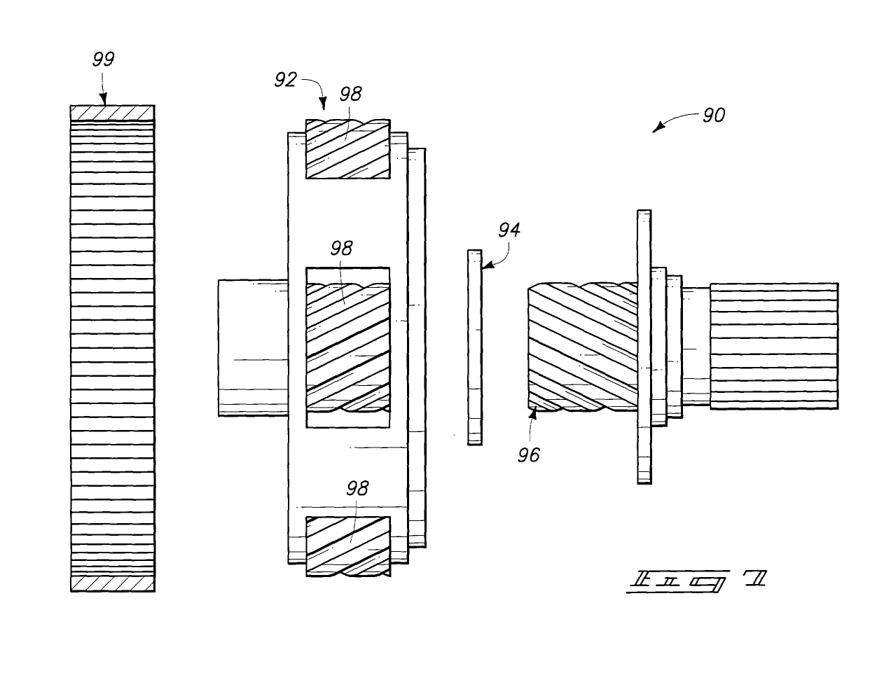

Referring to FIG. 7, an exemplary gear arrangement 90 is shown. Gear arrangement 90 includes an assembly 92, a thrust bearing 94, a sun gear 96, and an annulus or ring gear 99. Assembly 92 comprises a plurality of internally housed planetary gears 98 as shown. The depicted gear configuration 90 is exemplary and other gear arrangements are possible.

The depicted gear assembly 90 may be utilized as shown or with slight design modifications to implement planetary gear assemblies 36, 38, 40 of coupling device 21 to effect desired transmission ratios.

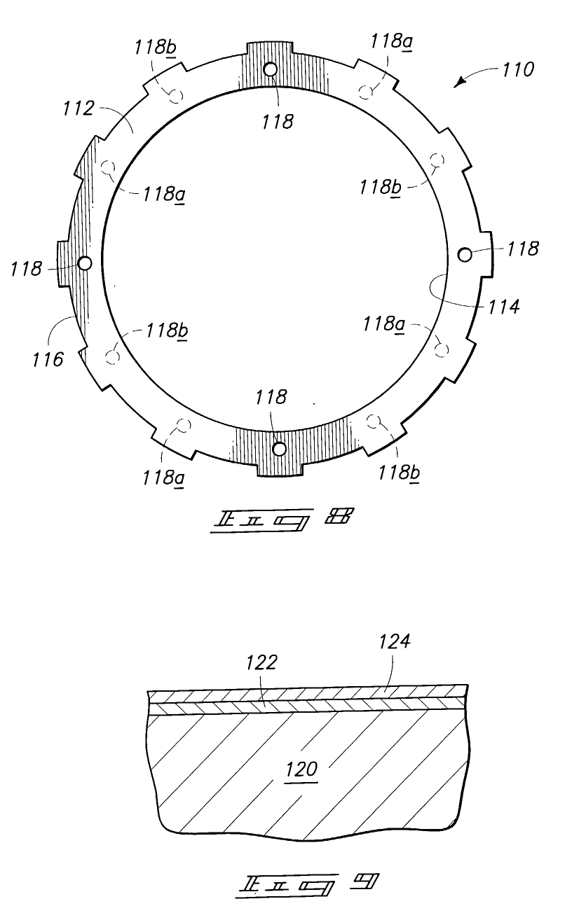

Referring to FIG. 8, an exemplary steel 110 is depicted. The configuration of steel 110 is illustrated for discussion of aspects of the present invention. Steel 110 may be provided as shown or with slight design modifications for use in any of clutch configurations 50, 60, 70, 80 discussed herein. The disclosed configuration of steel 110 is exemplary and aspects of the present invention may be utilized with other steel configurations.

Steel 110 generally comprises an annular member 112 having an inner surface 114 defining an inner radius and an outer surface 116 defining an outer radius. Annular member 112 includes one or more apertures 118 intermediate the inner surface 114 defining the inner radius and the outer surface 116 defining the outer radius. The depicted steel configuration 110 includes four such apertures 118. Other configurations of steels 110 include more or less apertures within respective annular members 112.

Apertures 118 pass through annular member 112 from a front surface thereof to a back surface thereof. In the described embodiment, apertures 118 have a diameter of a quarter inch. Apertures of other sizes may be utilized within steels 110.

A plurality of steels 110 of a given clutch pack may include apertures 118 within respective annular members 112. For example, all steels 110 or only selective steels 110 and annular members 112 thereof include such apertures 118.

Provision of apertures 118 permits passage of an appropriate fluid, such as transmission fluid, through annular member 112 of steel 110. Rotation of annular members 112 of steels 110 operates to create a vortex effect with fluid passing through respective apertures 118. Annular members 112 including apertures 118 according to aspects of the present invention provide increased flow of fluid within a given clutch pack containing the disclosed configuration of steels 110 shown in FIG. 8. Such operates to increase heat rejection capacities of coupling device 21 and transmission 16. Accordingly, longevity of coupling device 21 and transmission 16 is improved.

As shown, apertures 118 are spaced at substantially even distances from one another about the circumference of annular member 112 in the described embodiment. In the depicted arrangement, apertures 118 are located at approximately the twelve o'clock, three o'clock, six o'clock and nine o'clock positions of annular member 112. Apertures 118 are alternatively provided at other positions of annular member 112 in other configurations.

As described herein, a plurality of steels are typically utilized in a given clutch pack configuration. According to further aspects of the present invention, apertures of a given steel may be staggered with respect to apertures of other steels of a given clutch pack configuration. For example, depicted annular member 112 of FIG. 8 includes plural apertures 118 positioned as shown. Another steel (not shown) of the given clutch pack, perhaps adjacent to steel 110 depicted in FIG. 8, may be oriented with respect to the depicted steel 110 to include a plurality of apertures positioned as depicted by reference 118a in FIG. 8. Yet another steel (not shown) of the clutch pack, perhaps adjacent to the steel including apertures at positions 118a, may include a plurality of apertures positioned with respect to the depicted steel 110 at locations illustrated by reference 118b.

As depicted, apertures 118, 118a, 118b of respective steels are staggered or offset with respect to one another. The illustrated staggered pattern of apertures may be repeated for other steels of the clutch pack, if such are provided.

Referring to FIG. 9, further aspects of the present invention are discussed. Components of coupling device 21, such as steels, gears (e.g., planetary gear arrangement including a sun gear, planetary gears, and ring gear), rings, drums, and other components, comprise a base material, such as steel or other material. Components of coupling device 21 and transmission 16 including components configured to rotate responsive to rotation of one of shafts 17, 19 may be at least partially coated with one or more of layers 122, 124 depicted relative to a base material 120.

According to aspects of the present invention, plural layers or coatings 122, 124 are provided over base material 120 of at least some components of coupling device 21 and transmission 16. Alternatively, only one of layers 122, 124 is utilized for a given component. Further, the entire component or only a portion thereof may be coated with one or both layers 122, 124. Alternatively, one portion of a given component of coupling device 21 may be coated with one or both of layers 122, 124 and another portion of the component may be coated with the other or both of layers 122, 124.

In the described exemplary configuration, layer 122 provided upon base material 120 comprises a material having a hardness greater than base material 120. Layer 122 having a hardness greater than base material 120 increases heat dissipation within transmission 16 and also provides enhanced wear resistance of internal components of coupling device 21 and transmission 16 having such layer 122.

Layer 122 may be deposited upon base material 120 or other surface of an appropriate component of coupling device 21 or transmission 16 using a Plasma Vapor Deposition (PVD) process. In the described embodiment, layer 122 comprises titanium nitride (TiN) having an exemplary thickness of approximately 0.001″-0.003″. Layer 122 has other thicknesses in other embodiments.

Layer 124 provides a coefficient of friction of an appropriately coated component which is less than a coefficient of friction provided by a component having exposed base material 120 or exposed layer 122. Layer 124 is depicted formed upon layer 122 in FIG. 9. Alternatively, layer 124 is provided directly upon base material 120 of an appropriate component of coupling device 21 or transmission 16 in other arrangements.

An exemplary material of layer 124 is tungsten disulfide (WS₂). Such layer 124 reduces mechanical lubrication problems improving performance and extending life of appropriate components of transmission 16. Layer 124 may be provided upon layer 122 or directly upon base material 120 using a pressurized air application process impinging upon a dry metallic coating. An exemplary thickness of layer 124 is approximately 0.001″. Layer 124 has other thicknesses in other embodiments. Further details regarding formation of layers 122, 124 upon components of transmission 16 are available from BryCoat Inc. located in Safety Harbor, Fla. and at www.brycoat.com, incorporated herein by reference.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A transmission comprising:
a first shaft configured to rotate about an axis;
a second shaft configured to rotate about an axis; and
a coupling device coupled with the first shaft and the second shaft, the coupling device comprising a plurality of components configured to impart rotational forces received by one of the first and second shafts to the other of the first and second shafts and to provide a plurality of transmission ratios intermediate the first and second shafts, and wherein at least a portion of at least one of the components is coated with a first material different than a second material comprising the at least one coated component.

2. The transmission of claim 1 wherein the first material comprises titanium nitride.

3. The transmission of claim 1 wherein the first material comprises a layer of titanium nitride having a thickness of approximately 0.001″ to 0.003″.

4. The transmission of claim 1 wherein the first material comprises a layer of titanium nitride, and further comprising another layer comprising tungsten disulfide upon the layer of titanium nitride.

5. The transmission of claim 1 wherein the first material comprises a layer of titanium nitride, and further comprising another layer comprising tungsten disulfide upon the layer of titanium nitride.

6. The transmission of claim 1 wherein the first material has a hardness greater than the second material.

7. The transmission of claim 1 wherein the first material provides a coefficient of friction less than a coefficient of friction provided by the second material.

8. The transmission of claim 1 wherein the first material has a hardness greater than the second material and the at least one component additionally includes a layer of a third material over the first material and the third material provides a coefficient of friction less than a coefficient of friction provided by the first material.

9. The transmission of claim 1 wherein the at least one component is configured to rotate with at least one of the first shaft and the second shaft responsive to a received force.

10. The transmission of claim 1 wherein the at least one component comprises a planetary gear arrangement including a sun gear, plural planet gears and a ring gear.

11. The transmission of claim 1 wherein the at least one component comprises a plurality of steels of a clutch pack.

12. The transmission of claim 1 wherein the at least one component comprises a drum.

13. A vehicle comprising:
a support member;
an engine coupled with the support member and configured to provide a rotational force;
a transmission coupled with the engine, and comprising:
a first shaft configured to rotate about an axis;
a second shaft configured to rotate about an axis, wherein one of the first and second shafts is configured to receive the rotational force from the engine; and
a coupling device coupled with the first shaft and the second shaft, the coupling device comprising a plurality of components configured to impart the rotational force received by one of the first and second shafts to the other of the first and second shafts and to provide a plurality of transmission ratios intermediate the first and second shafts, and wherein at least a portion of at least one of the components is coated with a first material different than a second material comprising the at least one coated component.

14. The vehicle of claim 13 wherein the first material comprises titanium nitride.

15. The vehicle of claim 13 wherein the first material comprises a layer of titanium nitride having a thickness of approximately 0.001″ to 0.003″.

16. The vehicle of claim 13 wherein the first material comprises a layer of titanium nitride, and further comprising another layer comprising tungsten disulfide upon the layer of titanium nitride.

17. The vehicle of claim 13 wherein the first material has a hardness greater than the second material.

18. The vehicle of claim 13 wherein the first material provides a coefficient of friction less than a coefficient of friction provided by the second material.

19. The vehicle of claim 13 wherein the first material has a hardness greater than the second material and the at least one component additionally includes a layer of a third material over the first material and the third material provides a coefficient of friction less than a coefficient of friction provided by the first material.

20. The vehicle of claim 13 wherein the at least one component is configured to rotate with at least one of the first shaft and the second shaft responsive to a received force.

21. The vehicle of claim 13 wherein the at least one component comprises a planetary gear arrangement including a sun gear, plural planet gears and a ring gear.

22. The vehicle of claim 13 wherein the at least one component comprises a plurality of steels of a clutch pack.

23. The vehicle of claim 13 wherein the at least one component comprises a drum.

24. A method of forming a transmission comprising:
providing a first shaft configured to rotate about an axis;
providing a second shaft configured to rotate about an axis;
coupling a coupling device with the first shaft and the second shaft, the coupling device comprising a plurality of components configured to impart rotational forces received by one of the first and second shafts to the other of the first and second shafts and to provide a plurality of transmission ratios intermediate the first and second shafts; and
coating at least a portion of at least one of the components of the coupling device with a first material different than a second material comprising the at least one coated component.

25. The method of claim 24 wherein the coating comprises coating with the first material comprising titanium nitride.

26. The method of claim 24 wherein the coating comprises coating with the first material comprising tungsten disulfide.

27. The method of claim 24 wherein the coating comprises coating the first material to a thickness of approximately 0.001″ to 0.003″.

28. The method of claim 24 wherein the coating comprises coating with the first material comprising titanium nitride, and further comprising coating at least a portion of the first material with tungsten disulfide.

29. The method of claim 24 wherein the first material has a hardness greater than the second material.

30. The method of claim 24 wherein the first material provides a coefficient of friction less than a coefficient of friction provided by the second material.

31. The method of claim 24 wherein the first material has a hardness greater than the second material, and further comprising coating at least a portion of the first material with another material which provides a coefficient of friction less than a coefficient of friction provided by the first material.

32. The method of claim 24 wherein the coupling comprises coupling the coupling device including the components comprising a planetary gear arrangement, and the coating comprises coating at least one of a sun gear, plural planet gears and a ring gear of the planetary gear arrangement.

33. The method of claim 24 wherein the coupling comprises coupling the coupling device including the components comprising a clutch pack, and the coating comprises coating at least respective portions of plural steels of the clutch pack.

34. The method of claim 24 wherein the coupling comprises coupling the coupling device including the components comprising a drum, and the coating comprises coating at least a portion of the drum.

35. A clutch pack comprising:
a plurality of steels configured to rotate about an axis; and
a friction member positioned intermediate the steels and configured to selectively rotate with the steels and to selectively rotate independent of the steels, wherein the steels individually comprise an annular member having an inner radius and an outer radius, and at least one of the steels includes an aperture within the annular member intermediate the inner radius and outer radius.

36. The clutch pack of claim 35 wherein all the steels of the clutch pack individually include an aperture within the respective annular member intermediate the inner radius and outer radius.

37. The clutch pack of claim 35 wherein the at least one steel includes a plurality of apertures within the annular member intermediate the inner radius and the outer radius.

38. The clutch pack of claim 37 wherein the apertures are spaced at substantially even distances from one another about the circumference of the annular member.

39. The clutch pack of claim 38 wherein all the steels of the clutch pack individually include a plurality of apertures within the respective annular member intermediate the inner radius and outer radius, and the apertures of one steel are staggered with respect to the apertures of another steel.

40. A transmission clutch pack steel, the steel comprising an annular member having an inner radius and an outer radius, and at least one of the steels includes at least one aperture within the annular member intermediate the inner radius and outer radius.

41. The steel of claim 40 wherein the steel includes a plurality of apertures within the annular member intermediate the inner radius and the outer radius.

42. The steel of claim 41 wherein the apertures are spaced at substantially even distances from one another about the circumference of the annular member.

43. A vehicle comprising:
a support member;
an engine coupled with the support member and configured to provide a rotational force;
a transmission coupled with the engine, and comprising:
a first shaft configured to rotate about an axis;
a second shaft configured to rotate about an axis, wherein one of the first and second shafts is configured to receive the rotational force from the engine; and
a coupling device coupled with the first shaft and the second shaft, the coupling device comprising a plurality of components configured to impart the rotational force received by one of the first and second shafts to the other of the first and second shafts and to provide a plurality of transmission ratios intermediate the first and second shafts, and wherein the components of the coupling device include a clutch pack comprising:
a plurality of steels configured to rotate about an axis; and
a friction member positioned intermediate the steels and configured to selectively rotate with the steels and to selectively rotate independent of the steels, wherein the steels individually comprise an annular member having an inner radius and an outer radius, and at least one of the steels includes an aperture within the annular member intermediate the inner radius and outer radius.

44. The vehicle of claim 43 wherein all the steels of the clutch pack individually include an aperture within the respective annular member intermediate the inner radius and outer radius.

45. The vehicle of claim 43 wherein the at least one steel includes a plurality of apertures within the annular member intermediate the inner radius and the outer radius.

46. The vehicle of claim 45 wherein the apertures are spaced at substantially even distances from one another about the circumference of the annular member.

47. The vehicle of claim 46 wherein all the steels of the clutch pack individually include a plurality of apertures within the respective annular member intermediate the inner radius and outer radius, and the apertures of one steel are staggered with respect to the apertures of another steel.

48. A method of operating a transmission comprising:
providing a friction member;
providing a steel;
rotating the steel about an axis;
rotating the friction member about an axis;
selectively engaging the friction member with the steel; and
passing a fluid through the annular member at a location intermediate the inner radius and the outer radius during the rotating of the steel.

49. The method of claim 48 wherein the providing the steel comprises providing an annular member having an inner radius and an outer radius and at least one aperture within the annular member intermediate the inner radius and outer radius, wherein the passing comprises passing the fluid through the aperture within the annular member.
